(19) United States
(12) Patent Application Publication
(10) Pub. No.: US 2025/0324997 A1
(43) Pub. Date: Oct. 23, 2025

(54) Methods for Producing Instant White Coffee

(71) Applicant: Starbucks Corporation, Seattle, WA (US)

(72) Inventor: Denisley Gentil Bassoli, Port Orchard, WA (US)

(21) Appl. No.: 19/184,211

(22) Filed: Apr. 21, 2025

Related U.S. Application Data
(60) Provisional application No. 63/637,238, filed on Apr. 22, 2024.

(51) Int. Cl. A23F 5/26; A23F 5/04; A23F 5/08; A23F 5/18; A23F 5/24; A23F 5/34

(52) U.S. Cl. CPC A23F 5/262; A23F 5/04; A23F 5/08; A23F 5/18; A23F 5/243; A23F 5/34

(57) ABSTRACT

The disclosure relates to methods of making coffee extracts via extracting under a controlled pressure (e.g., a pressure equal to or greater than a saturation vapor pressure) and washing the extract at a low temperature (e.g., less than about 50° F.) to produce liquid coffee extract having a variety of different flavors and colors. The liquid coffee extract can then be further processed to obtain a dried coffee extract or instant coffee. This abstract is intended as a scanning tool for purposes of searching in the particular art and is not intended to be limiting of the present disclosure.

### CROSS-REFERENCE TO RELATED APPLICATIONS

This application claims the benefit of U.S. Application No. 63/637,238, filed on Apr. 22, 2024, the contents of which are incorporated herein by reference in their entirety.

### BACKGROUND

Aside from water, coffee is the most popular beverage in the world, with more than 400 billion cups consumed each year, and more than 450 million cups consumed daily in the United States alone. Coffee drinkers in the United States consume on average three and a half cups each day. The taste and flavor that consumers recognize as coffee is directly correlated with the roasting profile of the raw coffee beans.

Typically, coffee roasting is done using equipment known as roasters and begins using raw coffee beans such as, for example, raw green coffee beans, which have been previously processed and dried. The temperature of the coffee beans is raised progressively from ambient temperature to about 180 to 250° C. (356 to 482° F.) and heated for anywhere from 1 to 20 minutes, depending on the type of coffee bean, the type of roaster, and whether a light or dark final roast is desired.

As the temperature increases, several chemical reactions take place that provoke changes in color, flavor, and aroma. Milestones have been established for the commercialized roasting coffee process in terms of the most significant changes for each stage. For example, for a typical roasting, first comes a drying phase, followed by a turning point, wherein the coffee beans have lost enough moisture to start showing a physical reaction (i.e., when the natural (greenish) color starts turning light yellow until the final characteristic brown). The next important chemical reaction, the Maillard reaction, occurs around 150° C. (302° F.), which provokes changes in both color and flavor, followed by the Strecker degradation in which amino acids react with carbonyl-grouped molecules to create various compounds such as aldehydes and ketones. At about 170° C. (338° F.) comes the caramelization stage, where the heat causes complex carbohydrates to break down into sugar molecules. This contributes to the development of sweetness in the bean. The so-called “first crack” (a release of pressurized water from inside the beans) occurs around 196° C. (385° F.) and marks the end of this stage. The beginning of a third phase, often referred to as the development phase, is marked by a great release of carbon dioxide, the so-called “second crack,” which occurs at around 224° C. (436° F.). The elapsed time for this phase is ultimately determined by the end temperature, typically between 210-249° C. (410-480° F.). Depending on the level of roast and temperature reached, the coffee beans can yield a coffee extract ranging from a light roast (mild in flavor, fruity, more acidic) to a dark roast such as an Italian roast (more intense flavor).

The roasting profile can also impact the chemical make-up of the roasted coffee bean. For example, coffee beans are known to contain high amounts of antioxidant compounds known as polyphenols such as chlorogenic acids. Chlorogenic acids have substantial biological activities and studies suggest that they may offer a beneficial effect on glucose regulation and prevention of type 2 diabetes (Yang et al, J. Immunol Res, 2020, 9680508). Unfortunately, chlorogenic acids are degraded during the roasting process of coffee beans, wherein temperatures typically reach at least 177° C. (350° F.). Thus, coffee beans roasted to temperatures less than 177° C. (350° F.) yield higher concentrations of beneficial chlorogenic acids. Trigonelline, a NAD+-boosting with therapeutic potential for age-associated muscle decline (Membrez, M., Nature Metabolism, Vol 6, March 2024, p. 433-447), is also degraded.

More recently, white coffee has gained popularity. White coffee is coffee that is made from beans roasted at lower temperatures and for shorter amounts of time compared to typical coffee roasts. Typically, coffee beans are roasted to about 325° F. to produce white coffee beans. These beans yield a coffee extract that has a lighter color, higher acidity, and nutty flavor. While white coffee has certain potential benefits, such as having higher concentrations of chlorogenic acids due to the beans roasting at lower temperatures, producing white coffee is challenging. Roasting the beans at lower temperatures is difficult, as the beans must be removed from roasting before “first crack.” Thus, there is no auditory cue that roasters can rely on to assess whether the beans are roasted to the desired stage. Secondly, hardness of the beans is inversely related to roasting level, which can lead to difficulties during processing. Thus, lighter roast beans are harder and more difficult to grind compared to darker roast beans. As such, many conventional grinders are incapable of successfully grinding white coffee beans, as the hardness of the white coffee beans can affect the motor and break the blades. In general, the darker the bean the more soluble and, thus, easier to obtain highly concentrated extracts in good yield. As white coffee beans are an extremely light roast, solubility is a significant problem. Finally, although white coffee is known to have potential health benefits, the taste of white coffee tends to be highly acidic, astringent, weak, and otherwise unpleasant.

Despite the popularity of coffee and coffee-based beverages and the known potential benefits of white coffee, the ability to process roasted white coffee beans remains plagued with difficulties. Therefore, there remains a need for methods of producing instant white coffee that is highly soluble and readily processed into a coffee extract (e.g., white coffee solubles) with a mild, pleasant taste. These needs and others are met by the present invention.

### SUMMARY

In accordance with the purpose(s) of the invention, as embodied and broadly described herein, the invention, in one aspect, relates to methods of making coffee extracts via extracting under a controlled pressure (e.g., a pressure equal to or greater than a saturation vapor pressure) and washing the extract at a low temperature (e.g., less than about 50° F.) to produce liquid coffee extract having a variety of different flavors and colors. The liquid coffee extract can then be further processed to obtain a dried coffee extract or instant coffee.

Thus, disclosed are methods of making a coffee extract, the method comprising: (a) extracting roasted coffee beans at a pressure equal to or greater than a saturation vapor pressure, thereby providing an extract; and (b) washing the extract at a temperature of less than about 50° F.

Also disclosed are methods of making a coffee extract, the method comprising: (a) roasting coffee beans; (b) extracting the roasted coffee beans at a pressure equal to or greater than a saturation vapor pressure, thereby providing an extract; and (c) washing the extract at a temperature less than about 50° F.

Also disclosed are liquid coffee extracts made by a disclosed method.

Also disclosed are liquid coffee extracts comprising: (a) caffeine in an amount of from about 1 wt % to about 10 wt %; (b) a plurality of chlorogenic acids (CGAs); and (c) trigonelline, wherein the liquid coffee extract has a solubles concentration of at least about 90%; and wherein the coffee extract has an extraction yield of from about 15% to about 45%.

Also disclosed are food or beverage products comprising a disclosed liquid coffee extract.

Also disclosed are kits comprising a disclosed liquid coffee extract and one or more selected from: (a) a food or beverage product; and (b) instructions for adding the liquid coffee extract to a food or beverage product.

Also disclosed are methods of making a dried coffee extract, the method comprising: (a) extracting roasted coffee beans at a pressure equal to or greater than a saturation vapor pressure, thereby providing an extract; (b) washing the extract at a temperature less than about 50° F.; and (c) drying the extract.

Also disclosed are methods of making a dried coffee extract, the method comprising: (a) roasting coffee beans; (b) extracting the roasted coffee beans at a pressure equal to or greater than a saturation vapor pressure, thereby providing an extract; (c) clarifying the extract; (d) removing a plurality of aromatic components from the extract; (e) concentrating the extract; and (f) drying the extract.

Also disclosed are dried coffee extracts made by a disclosed method.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 shows a representative schematic depicting the roasting process for coffee beans.

FIG. 2 shows a representative flowchart outlining the steps for an exemplary method for roasting coffee beans.

FIG. 3 shows a representative flowchart outlining the steps for an exemplary method for extracting coffee beans.

FIG. 4A shows a representative schematic depicting an exemplary method for producing a coffee bean extract.

FIG. 4B shows a representative schematic depicting an alternative exemplary method for producing a coffee bean extract.

FIG. 5 shows representative images of exemplary and comparative coffee beans during different stages of the roasting process.

FIG. 6A-C show representative data for color testing readings performed on exemplary coffee beans roasted for 5 minutes, 6 minutes, and 7 minutes and on comparative Veranda roast (light roast) coffee beans, Blonde roast (light roast) coffee beans, Pike Place roast (medium roast) coffee beans, Verona roast (dark roast) coffee beans, and Italian roast (dark roast) coffee beans. The readings are recorded in the CIELAB color space.

FIG. 7 shows a representative spider chart for color testing readings performed on commercial roasted coffee beans compared to the exemplary roasted white coffee (“white coffee proposition”).

FIG. 8 shows a representative dendrogram for color testing readings performed on commercial roasted coffee compared to the exemplary roasted white coffee (“white coffee proposition”).

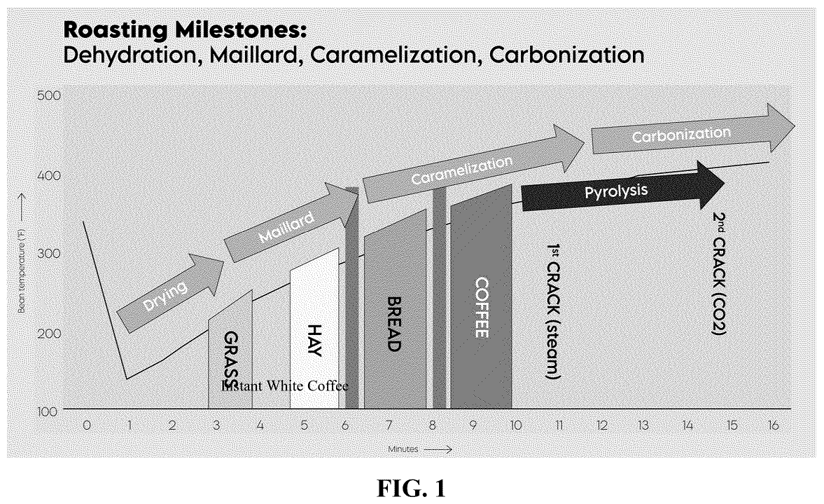

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present methods, coffee extracts, and beverages are disclosed and described, it is to be understood that they are not limited to specific methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Disclosed are the components to be used to perform the disclosed methods and prepare the coffee extracts and beverages of the invention as well as the coffee extracts and beverages themselves to be used within the methods disclosed herein. These and other materials are disclosed herein, and it is understood that when combinations, subsets, interactions, groups, etc. of these materials are disclosed that while specific reference of each various individual and collective combinations and permutation of these capsules cannot be explicitly disclosed, each is specifically contemplated and described herein. For example, if a particular coffee extract is disclosed and discussed and a number of modifications that can be made to a number of materials including the coffee extracts are discussed, specifically contemplated is each and every combination and permutation of the composition and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including steps in methods of making and using the capsules and compositions of the invention. Thus, if there are a variety of additional steps that can be performed it is understood that each of these additional steps can be performed with any specific embodiment or combination of embodiments of the methods of the invention.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. Definitions

As used in the specification and the appended claims, the singular forms “a,” “an” and “the” include plural referents unless the context clearly dictates otherwise. Thus, for example, reference to “a coffee extract” or “a beverage” includes mixtures of two or more such coffee extracts, beverages, and the like.

By “comprising” or “containing” or “having” it is intended that at least the named component, element, material, or method step, etc., is present in the coffee extract or beverage, but does not exclude the presence of other components, elements, materials, method steps, etc., even if the other such components, elements, materials, method steps, etc., have the same function as what is named, unless expressly excluded in the claims.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where said event or circumstance occurs and instances where it does not.

As used herein, the term “coffee extract” refers to a product obtained from coffee beans subjected to an extraction process. The coffee extracts can be, for example, products obtained by contacting whole or ground coffee beans with water, so as to dissolve soluble compounds with the water, which subsequently might be dried.

As used herein, the terms “beverage” and “beverage product” refer to a liquid good or product that is intended for consumption by, for example, a human. Examples of beverages include, but are not limited to, coffees such as instant coffees, cold brews, hot brews, traditional brews, and blended coffees, teas, fruit juices, smoothies, waters such as still waters and sparkling waters, liquors, liqueurs, mixtures thereof, carbonated beverages such as colas, lemon-lime sodas, fruit-flavored sodas, root beers, ginger ales, seltzers, tonic waters, beers, and sparkling waters.

As used herein, the terms “food” and “food product” refer to goods or products that are intended for consumption by, for example, a human. Examples of food and food products include, but are not limited to, syrups, sauces (e.g., mole), stews, meats (e.g., beef), alternative dairy products, desserts (e.g., ice creams, flans, cakes, custards, pies, yogurts, shaved ice, tarts), and dough-based food products (e.g., croissants, waffles, pancakes, breads).

As used herein, the term “roasting” refers to a method of applying heat to coffee beans to access desired aromas, flavors, and color. The roasting process typically releases steam, carbon dioxide, and other volatiles from the coffee beans. Conventionally, coffee beans are roasted to a final temperature ranging from about 385° F. (near “first crack) to about 455° F. As detailed herein, however, coffee beans are roasted at significantly lower temperatures, with a final temperature less than about 300° F.

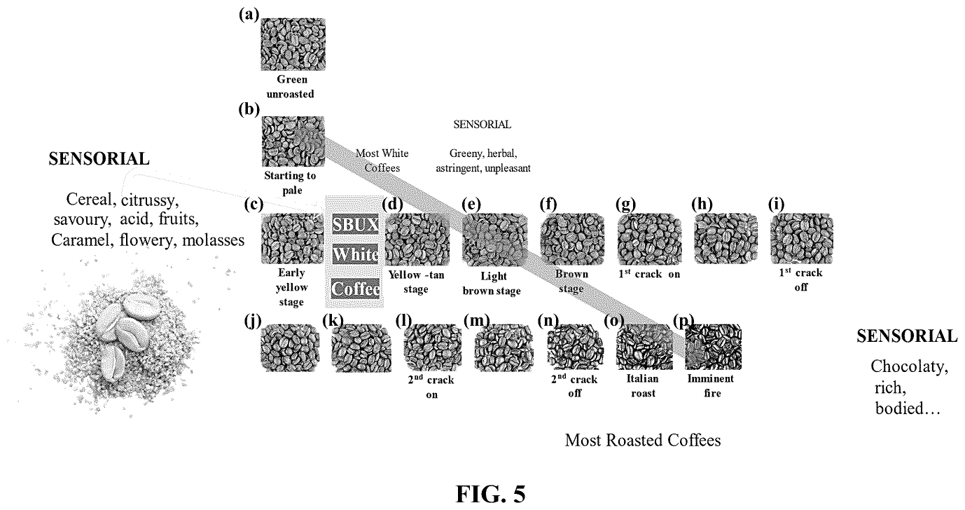

As used herein, the term “roasted coffee beans” refers to coffee beans that have been subjected to a roasting method, thereby altering the color, texture, and/or taste of the coffee bean. For example, roasted coffee beans can range in color from pale yellow to light brown to dark brown depending on the temperature and time that the beans are subject to roasting. Taste is also significantly impacted, with conventional roasted white coffees having a grassy, herbal taste and dark roast coffees having a chocolaty, rich, citrusy taste. In contrast, the instant roasted white coffee has a savory, fruity, caramel taste. See, e.g., FIG. 5.

As used herein, the terms “extracting” and “extraction” refer to a method of contacting roasted coffee beans (e.g., ground or whole roasted coffee beans) with water to release a number of desirable compounds such as caffeine, carbohydrates, lipids, melanoidins, and acids from the roasted coffee beans.

As used herein, the term “brew ratio” refers to the ratio of the amount of coffee extract (expressed in grams) to the amount of water (expressed as grams). As would be understood by one of skill in the art, the brew ratio can affect the strength and mouthfeel of the resultant beverage. Thus, an espresso, for example, typically has a brew ratio of from about 1:1 to about 1:4. Alternatively, coffees brewed using an immersion device tend to have a much lower ratio, from about 1:16 to about 1:20.

As used herein, the term “solubles” denotes substances in a coffee bean that can be dissolved by water. These solubles contribute to the flavor, aroma, and body of the resulting coffee extract. In general, a typical arabica roasted coffee bean contains about 20% solubles by weight when extracted using boiling water. Total Dissolved Solids (TDS) is a measure of the concentration of solubles extracted from the roasted coffee beans and dissolved in water during the extraction process. TDS plays a crucial role in the flavor balance of a coffee extract. A higher TDS concentration typically results in a stronger, more robust flavor, while a lower TDS concentration yields a lighter taste.

As used herein, the term “solubles concentration” is a measure of coffee strength and refers to the amount of solute particles (e.g., ground coffee) dissolved in a solution (e.g., water). As would be understood by one of skill in the art, a higher solubles concentration indicates that the resultant beverage or extract is stronger, while a lower solubles concentration indicates that the resultant beverage or extract is weaker (more “watery”). The solubles concentration in a coffee extract is typically expressed in parts per million (ppm), and can be measured with, for example, a refractometer.

As used herein, the term “extraction yield” means the percentage of coffee solubles extracted from the roasted coffee beans relative to their total mass. Extraction yield is directly correlated to TDS concentration, and can be calculated according to the formula:

Extraction yield=((M_{w}*% TDS)/M_{c}),

where M_{w} is the mass of the water in grams, % TDS is the total dissolved solids expressed as a percentage of the final beverage, and M_{c} is the mass of the roasted coffee beans before extraction. As would be understood by one of skill in the art, the extraction yield depends on a variety of different factors such as, for example, the water temperature, brewing time, size of grind, and the coffee-to-water ratio. Balancing these factors is important to the production of a coffee extract that is neither over- nor under-extracted.

As used herein, the term “saturation vapor pressure” means the vapor pressure at the point (i.e., a point of equilibrium) at which the rate of evaporation of a substance equals the rate of condensation such that the space at into which a liquid is evaporating is saturated.

### B. Methods of Roasting Coffee Beans

In one aspect, disclosed are methods of roasting coffee beans comprising roasting the coffee beans at a temperature of less than about 300° F. for a time period of about 10 minutes or less.

As detailed herein, the instantly disclosed methods beneficially produce roasted coffee beans having significantly improved solubility compared to conventional roasted white coffees. The resultant roasted coffee beans can be coarse ground or extracted directly, i.e., as a whole coffee bean. Typically, coffee beans are roasted at temperatures of from about 325° F. to about 480° F. By roasting coffee beans at temperatures of less than about 300° F., the resulting coffee beans retain higher concentrations of beneficial compounds, such as chlorogenic acids, which are degraded at higher roasting temperatures. The resultant roasted coffee beans also have a pleasant taste, being savory with a hint of fruits and caramel.

Coffee beans can be roasted using any process known in the art for producing roasted coffee beans. Exemplary roasting processes include, but are not limited to, drum roasting and hot air roasting.

The most traditional process for roasting coffee beans is drum roasting. In this type of roasting, coffee beans are placed in a cylinder-shaped drum, which is continuously rotated. As the drum is continuously rotated, the coffee beans are agitated, ensuring an even roast. Heat is provided using gas, electricity, wood, or an open flame underneath the drum. During roasting, the metal drum is heated, which then transfers heat to the coffe beans within.

A more modern approach to roasting coffee beans is hot air roasting. During hot air roasting, coffee is suspended in a convection current of hot air. This method ensures that the hot air envelopes every bean evenly to achieve a consistent roast. In contrast to drum roasting, during hot air roasting, the air is heated first, then blown through a roaster bed to heat the beans.

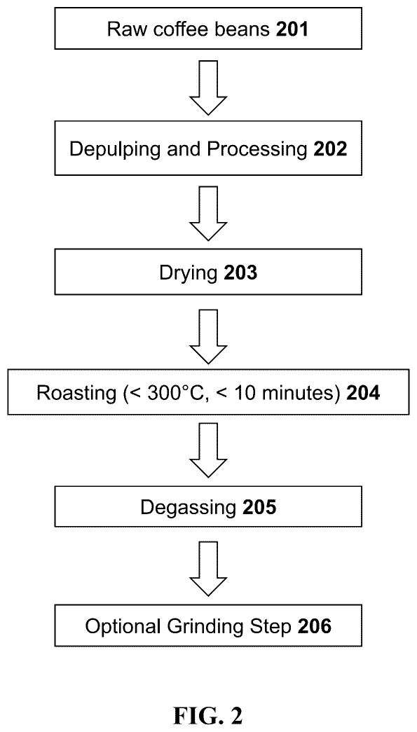

Referring to FIG. 2, for example, an exemplary roasting method as further described herein is shown. Raw coffee beans or coffee “cherries” 201 can be washed and depulped 202 to remove the flesh. Next, the coffee beans can be dried 203 using natural (air drying) or mechanical methods. The coffee beans are then roasted 204 (e.g., using methods such as drum roasting or hot air roasting) to a temperature less than about 300° F. for less than about 10 minutes. This is followed by a degassing step 205, in which the roasted coffee beans naturally release carbon dioxide. Prior to extraction, the roasted coffee beans can optionally be ground. Alternatively, whole roasted coffee beans can be used to produce coffee extracts.

The instantly disclosed methods can be used, without limitation, with any type of coffee bean known in the art. Exemplary coffee beans include, but are not limited to, Arabica beans, Robusta beans, Excelsa beans, Geisha/Gesha beans, and Liberica beans. Thus, in various aspects, the coffee beans are Arabica beans, Robusta beans, or a combination thereof. In a further aspect, the coffee beans are Robusta beans. In a still further aspect, the beans are Arabica beans.

In various aspects, the coffee beans are green coffee beans.

In various aspects, the roasting temperature is less than the roasting temperature of conventional coffee beans (e.g., 356° F. or greater). Thus, for example, the roasting temperature can be at least 10% less, at least 15% less, at least 20% less, at least 25% less, at least 30% less, at least 35% less, or at least 40% less than the roasting temperature of conventional coffee beans.

In various aspects, roasting is at a temperature of less than about 300° F. Thus, in various aspects, roasting is at a temperature of less than about 295° F., about 290° F., about 285° F., about 280° F., about 275° F., about 270° F., about 265° F., about 260° F., about 255° F., or about 250° F. In a further aspect, roasting is at a temperature of less than about 290° F.

In various aspects, roasting is at a temperature of from about 250° F. to about 300° F. Thus, in various aspects, roasting is at a temperature of from about 250° F. to about 290° F., about 250° F. to about 280° F., from about 250° F. to about 270° F., from about 250° F. to about 260° F., from about 260° F. to about 300° F., from about 270° F. to about 300° F., from about 280° F. to about 300° F., from about 290° F. to about 300° F., from about 260° F. to about 290° F., or from about 270° F. to about 280° F. In a further aspect, roasting is at a temperature of from about 260° F. to about 290° F. In a still further aspect, roasting is at a temperature of from about 265° F. to about 285° F.

In various aspects, roasting is for a short time period such as, for example, about 10 minutes or less. Thus, in various aspects, roasting is for a time period of about 9½ minutes or less, about 9 minutes or less, about 8½ minutes or less, about 8 minutes or less, about 7½ minutes or less, about 7 minutes or less, about 6½ minutes or less, about 6 minutes or less, about 5½ minutes or less, about 5 minutes or less, about 4½ minutes or less, about 4 minutes or less, about 3½ minutes or less, about 3 minutes or less, or about 2½ minutes or less. In a further aspect, roasting is for a time period of less than about 8 minutes.

In various aspects, roasting is for a time period of from about 2 minutes to about 10 minutes. Thus, in various aspects, roasting is for a time period of from about 2 minutes to about 9 minutes, about 2 minutes to about 8 minutes, about 2 minutes to about 7 minutes, about 2 minutes to about 6 minutes, about 2 minutes to about 5 minutes, about 2 minutes to about 4 minutes, about 2 minutes to about 3 minutes, about 3 minutes to about 9 minutes, about 4 minutes to about 9 minutes, about 5 minutes to about 9 minutes, about 6 minutes to about 9 minutes, about 7 minutes to about 9 minutes, about 8 minutes to about 9 minutes, about 3 minutes to about 8 minutes, about 4 minutes to about 7 minutes, or about 5 minutes to about 6 minutes. In a further aspect, roasting is for a time period of from about 2 minutes to about 7 minutes. In a still further aspect, roasting is for a time period of from about 5 minutes to about 7 minutes.

In various aspects, the method further comprises grinding the coffee beans after the roasting step, thereby providing ground coffee beans. As would be understood by one of ordinary skill, grinding can be accomplished by any traditional method known in the art such as, for example, a blade grinder, a burr grinder, a blender, an electric grinder, or a food processor.

In various aspects, the ground coffee beans have a coarse grind. Thus, in various aspects, the coffee beans are ground to an average particle size of about 7 mm (7000 μm) or greater. In various further aspects, the coffee beans are ground to an average particle size of about 7.5 mm or greater, about 8 mm or greater, about 8.5 mm or greater, about 9 mm or greater, or about 9.5 mm or greater. In various further aspects, the coffee beans are ground to an average particle size of about 8 mm or greater.

In various aspects, the coffee beans are ground to an average particle size of less than about 10 mm (10,000 μm). In various further aspects, the coffee beans are ground to an average particle size of less than about 9.5 mm, less than about 9 mm, less than about 8.5 mm, less than about 8 mm, or less than about 7.5 mm.

In various aspects, the coffee beans are ground to an average particle size of from about 7 mm (7000 μm) to about 10 mm (10,000 μm). Thus, in various aspects, the coffee beans are ground to an average particle size of from about 7 mm to about 9.5 mm, about 7 mm to about 9 mm, about 7 mm to about 8.5 mm, about 7 mm to about 8 mm, about 7 mm to about 7.5 mm, about 7.5 mm to about 10 mm, about 8 mm to about 10 mm, about 8.5 mm to about 10 mm, about 9 mm to about 10 mm, about 9.5 mm to about 10 mm, about 7.5 mm to about 9.5 mm, or about 8 mm to about 9 mm. In a further aspect, the coffee beans are ground to an average particle size of from about 8 mm to about 9 mm.

In various aspects, the method further comprises extracting the ground coffee beans.

In various aspects, the coffee beans are not ground after the roasting step.

In various further aspects, the method further comprises extracting the whole roasted coffee beans.

### C. Methods of Making a Coffee Extract

In one aspect, disclosed are methods of making a coffee extract, the method comprising: (a) extracting roasted coffee beans at a pressure equal to or greater than a saturation vapor pressure, thereby providing an extract; and (b) washing the extract at a temperature of less than about 50° F. In a further aspect, the pressure is at least 1 Bar or greater than a saturation vapor pressure.

In one aspect, disclosed are methods method of making a coffee extract, the method comprising: (a) roasting coffee beans; (b) extracting the roasted coffee beans at a pressure equal to or greater than a saturation vapor pressure, thereby providing an extract; and (c) washing the extract at a temperature less than about 50° F. In various aspects, when combined with a disclosed extraction method, the coffee beans can be roasted by any method known in the art. In various further aspects, roasting is via a roasting method as further detailed herein. In various further aspects, roasting is at a temperature of less than about 300° F. for a time period of about 10 minutes or less.

In one aspect, disclosed are methods of making a coffee extract, the method comprising: (a) roasting coffee beans at a temperature of less than about 300° F. for a time period of about 10 minutes or less; and (b) extracting the coffee beans. In various aspects, when combined with a disclosed roasting method, the roasted coffee beans can be extracted by any method known in the art. For example, the roasted coffee beans can be extracted using methods such as, but not limited to, pour over, French press, espresso, cold brewing, AeroPress, auto-drip brewing, vacuum filtration, decalktion, and percolation. In various further aspects, extracting is via an extraction method as further detailed herein.

In one aspect, disclosed are methods of making a coffee extract, the method comprising: (a) roasting coffee beans at a temperature of less than about 300° F. for a time period of about 10 minutes or less; (b) extracting the roasted coffee beans at a pressure equal to or greater than a saturation vapor pressure, thereby providing an extract; and (c) washing the extract at a temperature less than about 50° F.

As detailed herein, coffee extracts can be prepared by contacting roasted coffee beans with water. Although coffee beans are typically ground before extracting, as detailed herein, the disclosed coffee extracts can also be made using whole coffee beans roasted according to the roasting methods described herein. The extraction process releases a number of desirable compounds including caffeine, carbohydrates, lipids, melanoidins, and acids, from the roasted coffee beans into the water, thereby resulting in a coffee extract.

As used herein, the “size of the grind” refers to the coarseness or fineness of ground roasted coffee beans. Smaller, more finely ground roasted coffee beans have more surface area exposed to the water, making the solubles more readily available, leading to faster extraction times. Coarser grinds have a much smaller surface area exposed to water, and are more suited for slower extraction times.

The term “coffee-to-water ratio” refers to the proportion of whole or ground roasted coffee beans to water used in the extraction process. This ratio can also play an important role in the extraction yield and strength of the coffee extract. A higher coffee-to-water ratio will result in a stronger, more concentrated cup, while a lower ratio will result in a milder brew.

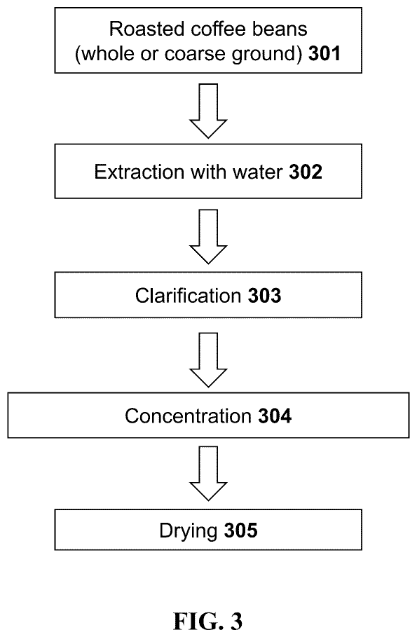

The exemplary extraction methods described in FIG. 2-3 cannot typically be performed with conventional roasted coffee beans roasted at lower temperatures (<350° F.). Such lower temperatures typically yield a very hard roasted coffee bean, which is challenging to grind using conventional grinding methods. Here, it has been discovered that the extraction process can be performed on the whole bean or, alternatively, on beans subject to a coarse grind, to afford a coffee extract having remarkable solubility.

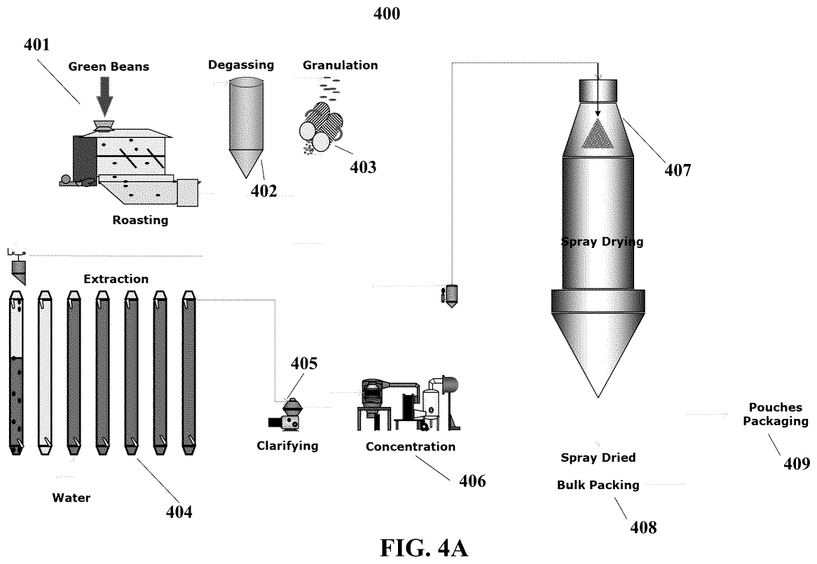

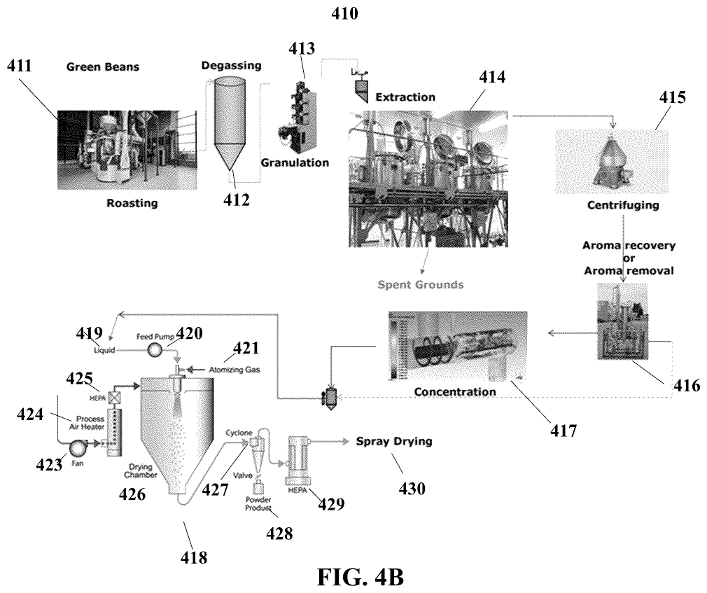

An exemplary roasting and extraction method is shown in FIG. 4A. As shown, coffee beans are roasted 401 as described herein for a set temperature (e.g., 300° F.) and roasting time (e.g., 5 min). After the coffee beans are finished roasting, the beans immediately begin to degas, or release carbon dioxide during a degassing step 402. The coffee beans are then fed into a grinder for an optional grinding step 403 and ground into fine particles through, for example, the use of rollers. The ground or whole roasted coffee beans are then brewed with water 404 to yield a coffee extract, which can optionally be clarified 405 and subjected to a series of extraction cells 406 to increase concentration. The water can then be removed via drying (e.g., spray drying) 407. The spray dryer sprays liquid coffee concentrate as a fine mist into very hot, dry air, yielding small crystals. The resultant soluble crystals can then be bulk packed 408 and packaged into pouches 409 for consumption.

Another exemplary roasting and extraction method is shown in FIG. 4B. As shown, coffee beans are roasted 411 as described herein for a set temperature (e.g., 300° F.) and roasting time (e.g., 5 min). After the coffee beans are finished roasting, the beans immediately begin to degas, or release carbon dioxide during a degassing step 412. The coffee beans are then fed into a granulator for an optional granulation step 413. The coffee beans are then brewed with water in an extraction step 414, followed by a centrifugation step 415. An optional aroma recovery or aroma removal step 416 may be performed, followed by concentration of the coffee extract 417. The spray drying step 418 can involve the liquid coffee extract 419 being fed into the drying chamber 426 via feed pump 420, and fine extract particles are formed via subjecting the particles to atomizing gas 421 and hot air. Hot air may be introduced into the drying chamber via fan 423, which feeds air into process air heater 424, and is filtered through HEPA filter 425 before introduction into the drying chamber. The dry particles can then be introduced into cyclone 427 and collected as the powder product 428. An additional HEPA filter 429 can be present if additional spray drying 430 is performed.

In various aspects, the coffee beans are green coffee beans.

In various aspects, the method further comprises, prior to the extracting step, grinding the coffee beans. As would be understood by one of ordinary skill, grinding can be accomplished by any traditional method known in the art such as, for example, a blade grinder, a burr grinder, a blender, an electric grinder, or a food processor.

In various aspects, prior to the extracting step, the coffee beans are ground to a coarse grind. Thus, in various aspects, prior to the extracting step, the coffee beans are ground to an average particle size of about 7 mm (7000 μm) or greater. In various further aspects, prior to the extracting step, the coffee beans are ground to an average particle size of about 7.5 mm or greater, about 8 mm or greater, about 8.5 mm or greater, about 9 mm or greater, or about 9.5 mm or greater. In various further aspects, prior to the extracting step, the coffee beans are ground to an average particle size of about 8 mm or greater.

In various aspects, prior to the extracting step, the coffee beans are ground to an average particle size of less than about 10 mm (10,000 μm). In various further aspects, prior to the extracting step, the coffee beans are ground to an average particle size of less than about 9.5 mm, less than about 9 mm, less than about 8.5 mm, less than about 8 mm, or less than about 7.5 mm.

In various aspects, prior to the extracting step, the coffee beans are ground to an average particle size of from about 7 mm (7000 μm) to about 10 mm (10,000 μm). Thus, in various aspects, prior to the extracting step, the coffee beans are ground to an average particle size of from about 7 mm to about 9.5 mm, about 7 mm to about 9 mm, about 7 mm to about 8.5 mm, about 7 mm to about 8 mm, about 7 mm to about 7.5 mm, about 7.5 mm to about 10 mm, about 8 mm to about 10 mm, about 8.5 mm to about 10 mm, about 9 mm to about 10 mm, about 9.5 mm to about 10 mm, about 7.5 mm to about 9.5 mm, or about 8 mm to about 9 mm. In a further aspect, prior to the extracting step, the coffee beans are ground to an average particle size of from about 8 mm to about 9 mm.

In various aspects, the coffee beans are not ground prior to the extracting step.

In various aspects, the coffee beans are extracted as whole beans.

In various aspects, extracting is via a percolator. In a further aspect, extracting is via an Aeropress.

In various aspects, extracting is at a temperature of about from about 250° F. to about 350° F. In a further aspect, extracting is at a temperature of about 295° F., about 296° F., about 2972° F., about 298° F., about 299° F., about 300° F., about 301° F., about 302° F., about 303° F., about 304° F., about 305° F., about 306° F., about 307° F., about 308° F., about 309° F., or about 310° F. In a still further aspect, extracting is at a temperature of about 302° F.

In various aspects, the method further comprises extracting at a temperature of less than about 302° F. Thus, in various aspects, the method further comprises extracting at a temperature of less than about 290° F., less than about 280° F., less than about 270° F., less than about 260° F., or less than about 250° F.

In various aspects, the method further comprises clarifying the extract. In a further aspect, clarifying is via filtering or centrifuging. In a still further aspect, the clarifying step is repeated until the extract does not contain particles having a size of about 5 micrometers or greater.

In various aspects, the method further comprises removing a plurality of aromatic components from the extract. In a further aspect, the plurality of aromatic component comprises one or more selected from 2-furfurylthiole, 3-mercapto-3-methylbutylformate, 3-methyl-2-buten-1-thiol, 2-isobutyl-3-methoxypyrazine, 5-ethyl-4-hydroxy-2-methyl-3(2H)-furanone, 2,3-butanedione (diacetyl), 2,3-pentanedione, methional, 2-isopropyl-3-methoxypyrazine, vanillin, 4-hydroxy-2,5-dimethyl-3(2H)-furanone, 2-ethyl-3,5-dimethylpyrazine, 2,3-diethyl-5-methylpyrazine, 3-hydroxy-4,5-dimethyl-2(5H)-furanone, and 5-ethyl-3-hydroxy-4-methyl-2(5H)-furanone. In a still further aspect, the aromatic component consists of one or more selected from 2-furfurylthiole, 3-mercapto-3-methylbutylformate, 3-methyl-2-buten-1-thiol, 2-isobutyl-3-methoxypyrazine, 5-ethyl-4-hydroxy-2-methyl-3(2H)-furanone, 2,3-butanedione (diacetyl), 2,3-pentanedione, methional, 2-isopropyl-3-methoxypyrazine, vanillin, 4-hydroxy-2,5-dimethyl-3(2H)-furanone, 2-ethyl-3,5-dimethylpyrazine, 2,3-diethyl-5-methylpyrazine, 3-hydroxy-4,5-dimethyl-2(5H)-furanone, and 5-ethyl-3-hydroxy-4-methyl-2(5H)-furanone. In yet a further aspect, removing is via extract stripping, spinning, or distillation.

In various further aspects, the extracting step produces an extract, and the method further comprises concentrating the extract. Methods of concentrating an extract are well-known by those of skill in the art and include, but are not limited to, thermal processing, evaporation, and reverse osmosis.

In various aspects, concentrating is via thermal processing. In a still further aspect, thermal processing is at a temperature of about 150° F. or less. Thus, in various aspects, thermal processing is at a temperature of about 145° F. or less, about 140° F. or less, or about 130° F. or less. In yet a further aspect, thermal processing is at a temperature of from about 115° F. to about 150° F. In a still further aspect, thermal processing is at a temperature of from about 122° F. to about 140° F.

In various aspects, concentrating is via freeze concentration or reverse osmosis.

In various aspects, the concentrating step produces a concentrated extract, and wherein the method further comprises drying the concentrated extract. Methods of drying an extract are well-known by those of skill in the art and include, but are not limited to, spray drying. In various further aspects, the drying step produces coffee crystals.

In various aspects, the extracting step produces an extract, and wherein the method further comprises drying the extract. In a further aspect, drying is via spray drying. In a still further aspect, drying is via a drying tower. In yet a further aspect, the drying tower comprises one or more selected from a hammer, a wiper, and sound equipment. In a still further aspect, the drying step produces coffee crystals.

In various aspects, the method comprises: (a) extracting roasted coffee beans at a pressure equal to or greater than a saturation vapor pressure, thereby providing an extract; (b) washing the extract at a temperature of less than about 50° F.; (c) clarifying the extract; and (d) concentrating the clarified extract. In various aspects, prior to step (d), the method further comprises removing a plurality of aromatic components from the extract. In various further aspects, the method further comprises drying the concentrated extract.

In various aspects, the method comprises: (a) extracting roasted coffee beans at a pressure equal to or greater than a saturation vapor pressure, thereby providing an extract; (b) washing the extract at a temperature of less than about 50° F.; (c) removing a plurality of aromatic components from the extract; and (d) concentrating the extract. In a further aspect, the method further comprises adding at least a portion of the plurality of aromatic components to the concentrated extract. In a still further aspect, the plurality of aromatic components are not added back to the concentrated extract. In yet a further aspect, the method further comprises drying the concentrated extract.

In various aspects, the method comprises: (a) extracting roasted coffee beans at a pressure equal to or greater than a saturation vapor pressure, thereby providing an extract; (b) washing the extract at a temperature less than about 50° F.; (c) clarifying the extract; (d) removing a plurality of aromatic components from the extract; and (e) concentrating the extract. In a further aspect, the method further comprises adding at least a portion of the plurality of aromatic components to the concentrated extract. In a still further aspect, the plurality of aromatic components are not added back to the concentrated extract. In yet a further aspect, the method further comprises drying the concentrated extract.

In various aspects, the dried extract is highly soluble in water. Thus, in various aspects, the dried extract can be, for example, at least 50%, 60%, 70%, 80%, 90%, 95%, or at least 99% soluble in water.

### D. Methods of Making a Dried Coffee Extract

In one aspect, disclosed are methods of making a dried coffee extract, the method comprising: (a) extracting roasted coffee beans at a pressure equal to or greater than a saturation vapor pressure, thereby providing an extract; (b) washing the extract at a temperature less than about 50° F.; and (c) drying the extract.

In one aspect, disclosed are methods of making a dried coffee extract, the method comprising: (a) roasting coffee beans; (b) extracting the roasted coffee beans at a pressure equal to or greater than a saturation vapor pressure, thereby providing an extract; (c) washing the extract at a temperature less than about 50° F.; and (d) drying the extract. In various aspects, roasting is at a temperature of less than about 300° F. for a time period of about 10 minutes or less.

In one aspect, disclosed are methods of making a dried coffee extract, the method comprising: (a) roasting coffee beans; (b) extracting the roasted coffee beans at a pressure equal to or greater than a saturation vapor pressure, thereby providing an extract; (c) clarifying the extract; (d) removing a plurality of aromatic components from the extract; (e) concentrating the extract; and (f) drying the extract.

In various aspects, the method further comprises, prior to the drying step, clarifying the extract. In a further aspect, clarifying is via filtering or centrifuging. In a still further aspect, the clarifying step is repeated until the extract does not contain particles having a size of about 5 micrometers or greater.

In various aspects, the method further comprises, prior to the drying step, removing a plurality of aromatic components from the extract. In a further aspect, the plurality of aromatic component comprises one or more selected from 2-furfurylthiole, 3-mercapto-3-methylbutylformate, 3-methyl-2-buten-1-thiol, 2-isobutyl-3-methoxypyrazine, 5-ethyl-4-hydroxy-2-methyl-3(2H)-furanone, 2,3-butanedione (diacetyl), 2,3-pentanedione, methional, 2-isopropyl-3-methoxypyrazine, vanillin, 4-hydroxy-2,5-dimethyl-3(2H)-furanone, 2-ethyl-3,5-dimethylpyrazine, 2,3-diethyl-5-methylpyrazine, 3-hydroxy-4,5-dimethyl-2(5H)-furanone, and 5-ethyl-3-hydroxy-4-methyl-2(5H)-furanone. In a still further aspect, the aromatic component consists of one or more selected from 2-furfurylthiole, 3-mercapto-3-methylbutylformate, 3-methyl-2-buten-1-thiol, 2-isobutyl-3-methoxypyrazine, 5-ethyl-4-hydroxy-2-methyl-3(2H)-furanone, 2,3-butanedione (diacetyl), 2,3-pentanedione, methional, 2-isopropyl-3-methoxypyrazine, vanillin, 4-hydroxy-2,5-dimethyl-3(2H)-furanone, 2-ethyl-3,5-dimethylpyrazine, 2,3-diethyl-5-methylpyrazine, 3-hydroxy-4,5-dimethyl-2(5H)-furanone, and 5-ethyl-3-hydroxy-4-methyl-2(5H)-furanone. In yet a further aspect, removing is via extract stripping, spinning, or distillation.

In various aspects, the method further comprises, prior to the drying step, concentrating the extract. Methods of concentrating an extract are well-known by those of skill in the art and include, but are not limited to, thermal processing, evaporation, and reverse osmosis.

In various aspects, concentrating is via thermal processing. In a still further aspect, thermal processing is at a temperature of about 150° F. or less. Thus, in various aspects, thermal processing is at a temperature of about 145° F. or less, about 140° F. or less, or about 130° F. or less. In yet a further aspect, thermal processing is at a temperature of from about 115° F. to about 150° F. In a still further aspect, thermal processing is at a temperature of from about 122° F. to about 140° F.

In various aspects, concentrating is via freeze concentration or reverse osmosis.

In various aspects, the concentrating step produces a concentrated extract, and wherein the method further comprises drying the concentrated extract. Methods of drying an extract are well-known by those of skill in the art and include, but are not limited to, spray drying. In various further aspects, the drying step produces coffee crystals.

In various aspects, the extracting step produces an extract, and wherein the method further comprises drying the extract. In a further aspect, drying is via spray drying. In a still further aspect, drying is via a drying tower. In yet a further aspect, the drying tower comprises one or more selected from a hammer, a wiper, and sound equipment. In a still further aspect, the drying step produces coffee crystals.

In various aspects, the dried extract is highly soluble in water. Thus, in various aspects, the dried extract can be, for example, at least 50%, 60%, 70%, 80%, 90%, 95%, or at least 99% soluble in water.

### E. Roasted Coffee Beans

In one aspect, disclosed are roasted coffee beans prepared by a disclosed method. Thus, in a further aspect, disclosed are roasted coffee beans comprising: (a) caffeine in an amount of from about 4.8 wt % to about 5.2 wt %; (b) a plurality of polyphenols; and (c) trigonelline, wherein the roasted coffee beans have a concentration of at least about 1%; and wherein the coffee beans have a color test number (L*) of about 40 or greater. In a still further aspect, disclosed are roasted coffee beans comprising: (a) caffeine in an amount of from about 4.8 wt % to about 5.2 wt %; (b) a plurality of polyphenols; and (c) trigonelline, wherein the coffee beans have a color test number (L*) of about 40 or greater.

As detailed herein, the disclosed roasted coffee beans, which are roasted at low temperatures (e.g., less than about 300° F.) for short time periods (e.g., about 10 minutes or less) are beneficially more tasteful (e.g., more savory), pale in color (e.g., from early yellow stage to yellow-tan stage; see FIG. 5), and more soluble in water compared to conventional roasted coffee beans, which are roasted at higher temperatures (>350° F.). Furthermore, the disclosed roasted coffee beans can be used to produce a coffee extract without the need for a grinding step, i.e., the extract can be obtained directly from the whole roasted coffee beans.

Due to the lower temperatures and lower roasting times, the resulting roasted coffee beans can have a higher amount of moisture compared to coffee beans roasted at higher temperatures for longer times. Thus, the disclosed roasted coffee beans can have a lower amount of weight loss before and after roasting compared to coffee beans roasted at higher temperatures for longer times. Total weight loss is expressed as g/100 g and is calculated by weighing roasted coffee bean samples before and after roasting. Thus, in various aspects, the disclosed roasted coffee beans can have, for example, a total weight loss during roasting of from about 3% to about 8%, from about 3% to about 6%, from about 3% to about 4%, from about 4% to about 8%, from about 6% to about 8%, or from about 4% to about 6%.

Moreover, it is well established that the roasting profile can impact the taste of the roasted coffee beans. The instant roasted coffee beans have a savory flavor (e.g., cereal, fruits, caramel), which flavor was previously unable to be accessed due to the established difficulties with processing (e.g., extracting) coffee beans roasted at lower temperatures (e.g., about 350° F.).

Not only are characteristic aromas and flavors developed during the roasting process, but the effects of heating and degree of roast can also be characterized by the color of the roasted coffee beans, which is quantified using three color values: a lightness value (L*), a green to red spectrum value (a*), and a blue to yellow spectrum value (b*). These values can be measured using any conventional technique such as, for example, a photometer or CIELAB (also known as CIE L*a*b*). CIELAB is a 3D color space that enables measurement and comparison of all perceivable colors using these three color values.

L* represents lightness from black to white on a scale of zero to 100. The higher the value of L*, the lower the roasting index. For example, dark or very dark roast coffee beans typically have a L* value of about 28.99 or less. Medium roast coffee beans can have a L* value of from about 29 to about 41.99. Light roast coffee beans can have a L* value of about 42 or greater. L* can be measured using any conventional technique such as, for example, using a photometer. Thus, in various aspects, the disclosed roasted coffee beans can have a L* value of about 36 or greater. In various further aspects, the disclosed roasted coffee beans can have a L* value of about 37 or greater, about 40 or greater, about 42 or greater, or about 57 or greater. In various further aspects, the disclosed roasted coffee beans can have a L* value of from about 30 to about 60, about 30 to about 55, about 30 to about 50, about 30 to about 45, about 30 to about 40, about 30 to about 35, about 35 to about 55, about 35 to about 50, about 35 to about 45, about 30 to about 40, about 40 to about 55, about 40 to about 50, about 40 to about 45, about 45 to about 55, or about 50 to about 55 as measured by a photometer. In various further aspects, the disclosed roasted coffee beans can have, for example, a lightness value of about 30, about 35, about 40, about 45, about 50, or about 55 as measured by a photometer.

a* and b* represent chromaticity and have no specific numeric limits. A higher a* value corresponds with red, while a lower a* value corresponds with green. blue. Thus, in various aspects, the disclosed roasted coffee beans can have an a* value of about 2.5 or less, about 2.4 or less, about 2.3 or less, about 2.2 or less, about 2.1 or less, about 2.0 or less, about 1.9 or less, about 1.8 or less, about 1.7 or less, or about 1.6 or less. In various further aspects, the disclosed roast coffee beans can have an a* value of from about 1.5 to about 2.5, about 1.5 to about 2.3, about 1.5 to about 2.1, about 1.5 to about 1.9, about 1.5 to about 1.7, about 1.7 to about 2.5, about 1.9 to about 2.5, about 2.1 to about 2.5, about 2.3 to about 2.5, about 1.7 to about 2.3, or about 1.9 to about 2.1. In various further aspect, the disclosed roasted coffee beans can have an a* value of about 2.4, about 2.2, about 2.0, about 1.8, or about 1.6.

For b* values, a higher b* value corresponds with yellow and a lower b* value corresponds with blue. Thus, in various aspects, the disclosed roasted coffee beans can have a b* value of about 8 or greater, about 10 or greater, about 12 or greater, about 14 or greater, or about 16 or greater. In various further aspect, the disclosed roasted coffee beans can have a b* value of from about 8 to about 16, about 8 to about 14, about 8 to about 12, about 8 to about 10, about 10 to about 16, about 12 to about 16, about 14 to about 16, or about 10 to about 14.

As detailed herein, the disclosed roasted coffee beans can retain higher concentrations of caffeine due to being roasted at lower temperatures, which prevents its degradation and losses during roasting, compared to conventionally roasted coffee beans. Thus, in various aspects, the dried extract obtained from the disclosed roasted coffee beans contains caffeine in an amount of from about 4% to about 6% (db), from about 4% to about 5.5% (db), from about 4% to about 5% (db), from about 4% to about 4.5% (db), from about 4.5% to about 6% (db), from about 5% to about 6% (db), from about 5.5% to about 6% (db), or from about 4.5% to about 5.5% (db).

As detailed herein, the disclosed roasted coffee beans can retain higher concentrations of total chlorogenic acids due to being roasted at lower temperatures, which prevents the degradation of chlorogenic acids, compared to conventionally roasted coffee beans. Thus, in various aspects, the dried extract obtained from the disclosed roasted coffee beans contain total chlorogenic acids in an amount of from about 20% to about 30% (db), from about 20% to about 28% (db), from about 20% to about 26% (db), from about 20% to about 24% (db), from about 20% to about 22% (db), from about 22% to about 30% (db), from about 24% to about 30% (db), from about 26% to about 30% (db), from about 28% to about 30% (db), from about 22% to about 28% (db), or from about 24% to about 26% (db).

As detailed herein, the disclosed roasted coffee beans can retain higher concentrations of the main chlorogenic acid, 5-caffeoylquinic acid, due to being roasted at lower temperatures, which prevents its degradation, compared to conventionally roasted coffee beans. Thus, in various aspects, the dried extract obtained from the disclosed roasted coffee beans contains 5-caffeoylquinic acid in an amount of from about 8% to about 15%, from about 8% to about 12%, from about 8% to about 10%, from about 10% to about 15%, from about 12% to about 15%, or from about 10% to about 12%.

As detailed herein, the disclosed roasted coffee beans can retain higher concentrations of trigonelline due to being roasted at lower temperatures, which prevents its degradation, compared to conventionally roasted coffee beans. Thus, in various aspects, the dried extract obtained from the disclosed roasted coffee beans contain trigonelline in an amount of from about 3% to about 7%, from about 3% to about 5%, from about 5% to about 7%, or from about 4% to about 6%.

In various aspects, the roasted coffee beans have a concentration of at least about 1%. In a further aspect, the roasted coffee beans have a concentration of at least about 2%, at least about 3%, at least about 4%, at least about 5%, or greater than about 5%.

In various aspects, the roasted coffee beans have a lightness (L*) color test number (CTN) of from about 30 to about 50. In a further aspect, the roasted coffee beans have a lightness (L*) color test number (CTN) of from about 30 to about 45, from about 30 to about 40, from about 30 to about 35, from about 35 to about 50, from about 40 to about 50, from about 45 to about 50, or from about 35 to about 45.

In various aspects, the roasted coffee beans have a lightness (L*) color test number (CTN) of about 40 or greater. In a further aspect, the roasted coffee beans have a lightness (L*) color test number (CTN) of about 41 or greater, about 42 or greater, about 43 or greater, about 44 or greater, or about 45 or greater.

In various aspects, the roasted coffee beans have a red-green (a*) color test number (CTN) of from about 1.5 to about 2.5. In a further aspect, the roasted coffee beans have a red-green (a*) color test number (CTN) of from about 1.5 to about 2.25, from about 1.5 to about 2.0, from about 1.5 to about 1.75, from about 1.75 to about 2.5, from about 2.0 to about 2.5, from about 2.25 to about 2.5, or from about 1.75 to about 2.25.

In various aspects, the roasted coffee beans have a blue-yellow (b*) color test number (CTN) of at least about 10. In a further aspect, the roasted coffee beans have a blue-yellow (b*) color test number (CTN) of at least about 11, at least about 12, at least about 13, at least about 14, or at least about 15.

### F. Coffee Extracts

In one aspect, disclosed are coffee extracts prepared by a disclosed method. The coffee extracts described herein are beneficially more tasteful (e.g., more savory) and are produced in greater quantities compared to coffee extracts derived from conventional roasted white coffee (i.e., the disclosed roasted coffee beans have a greater solubles content).

As detailed herein, the disclosed coffee extracts can be provided in a liquid form (a liquid coffee extract) or can be dehydrated (dried) to form a solid form (solubles; dried coffee extract). Liquid forms of the coffee extracts can be, for example, coffee extracts that have been produced by extracting solubles with water via a method such as French press. Alternatively, solid forms of the coffee extracts can be obtained by, for example, drying the liquid extract to afford solid, coffee crystals have 100% or nearly 100% solubility in water. These coffee crystals can be directly dissolved in water (e.g., to provide an instant coffee). Without wishing to be bound by theory, the improved solubility of the disclosed roasted coffee beans, coffee extracts, and coffee crystals should also lead to improvements in stability (shelf life, taste) and in product yield.

### 1. Liquid Coffee Extracts

As disclosed herein, the disclosed coffee extract contains higher concentrations of caffeine compared to coffee extracts obtained from coffee beans that are roasted at higher temperatures (e.g., 350° F. or more). Thus, in various aspects, the disclosed liquid coffee extract contains caffeine in an amount of from about 4% to about 6% (db), from about 4% to about 5.5% (db), from about 4% to about 5% (db), from about 4% to about 4.5% (db), from about 4.5% to about 6% (db), from about 5% to about 6% (db), from about 5.5% to about 6% (db), or from about 4.5% to about 5.5% (db).

The disclosed coffee extract also contains higher concentrations of chlorogenic acids due to the beans having been roasted at lower temperatures. The low temperature roasting profile prevents the degradation of chlorogenic acids in the beans compared to conventionally roasted coffee beans. Thus, in various aspects, the disclosed liquid coffee extract contains total chlorogenic acids in an amount of from about 20% to about 30% (db), from about 20% to about 28% (db), from about 20% to about 26% (db), from about 20% to about 24% (db), from about 20% to about 22% (db), from about 22% to about 30% (db), from about 24% to about 30% (db), from about 26% to about 30% (db), from about 28% to about 30% (db), from about 22% to about 28% (db), or from about 24% to about 26% (db).

The disclosed coffee extract also contains higher concentrations of the main chlorogenic acid, 5-caffeoylquinic acid, due to the low temperature of the roasting profile. Thus, in various aspects, the disclosed liquid coffee extract contains 5-caffeoylquinic acid in an amount of from about 8% to about 15%, from about 8% to about 12%, from about 8% to about 10%, from about 10% to about 15%, from about 12% to about 15%, or from about 10% to about 12%.

As detailed herein, the disclosed coffee extract also contains higher concentrations of trigonelline due to the coffee beans having been roasted at lower temperatures, which prevents degradation of trigonelline, compared to conventionally roasted coffee beans. Thus, in various aspects, the disclosed liquid coffee extract contains trigonelline in an amount of from about 3% to about 7%, from about 3% to about 5%, from about 5% to about 7%, or from about 4% to about 6%.

As detailed herein, the disclosed coffee extracts are quite strong (not watery) due to the high solubility of the roasted coffee bean. Thus, in various aspects, the disclosed liquid coffee extracts have a solubles concentration of at least about 90%, at least about 91%, at least about 92%, at least about 93%, at least about 94%, at least about 95%, at least about 96%, at least about 97%, at least about 98%, at least about 99%, or greater than 99%.

In various aspects, the disclosed liquid coffee extracts have an excellent extraction yield. Thus, in various aspects, the disclosed coffee extracts have an extraction yield of from about 15% to about 45%. In various further aspects, the disclosed coffee extracts have an extraction yield of, for example, about 15% to about 40%, about 15% to about 30%, about 15% to about 20%, about 20% to about 45%, about 20% to about 40%, about 20% to about 35%, about 20% to about 30%, about 30% to about 45%, about 30% to about 40%, about 30% to about 35%, about 35% to about 45%, about 35% to about 40%, or about 40% to about 45%. In various further aspects, the disclosed coffee extracts have an extraction yield of, for example, about 15%, about 20%, about 25%, about 30%, about 35%, about 40%, or about 45%.

### 2. Dried Coffee Extracts (Solubles)

In one aspect, disclosed are dried coffee extracts comprising: (a) caffeine in an amount of from about 4 wt % to about 7 wt %; (b) a plurality of polyphenols comprising 5-caffeoyl quinic acid (5-CQA), wherein the 5-CQA is present in the dried coffee extract in an amount of from about 9 wt % to about 15 wt %; and (c) trigonelline in an amount of from about 3 wt % to about 7 wt %.

As disclosed herein, the disclosed coffee extract contains higher concentrations of caffeine compared to coffee extracts obtained from coffee beans that are roasted at higher temperatures (e.g., 350° F. or more). Thus, in various aspects, the disclosed dried coffee extract contains caffeine in an amount of from about 4% to about 6% (db), from about 4% to about 5.5% (db), from about 4% to about 5% (db), from about 4% to about 4.5% (db), from about 4.5% to about 6% (db), from about 5% to about 6% (db), from about 5.5% to about 6% (db), or from about 4.5% to about 5.5% (db).

The disclosed coffee extract also contains higher concentrations of chlorogenic acids due to the beans having been roasted at lower temperatures. The low temperature roasting profile prevents the degradation of chlorogenic acids in the beans compared to conventionally roasted coffee beans. Thus, in various aspects, the disclosed dried coffee extract contains total chlorogenic acids in an amount of from about 20% to about 30% (db), from about 20% to about 28% (db), from about 20% to about 26% (db), from about 20% to about 24% (db), from about 20% to about 22% (db), from about 22% to about 30% (db), from about 24% to about 30% (db), from about 26% to about 30% (db), from about 28% to about 30% (db), from about 22% to about 28% (db), or from about 24% to about 26% (db).

In various aspects, the dried coffee extract comprises caffeine in an amount of from about 1 wt % to about 9 wt %, from about 1 wt % to about 7 wt %, from about 1 wt % to about 5 wt %, from about 1 wt % to about 3 wt %, from about 3 wt % to about 9 wt %, from about 5 wt % to about 9 wt %, from about 7 wt % to about 9 wt %, or from about 3 wt % to about 7 wt %. In a further aspect, the dried coffee extract comprises caffeine in an amount of from about 4 wt % to about 7 wt %.

In various aspects, the plurality of polyphenols are present in an amount of from about 15 wt % to about 35 wt %. Thus, in various aspects, the plurality of polyphenols are present in an amount of from about 20 wt % to about 35 wt %, from about 25 wt % to about 35 wt %, from about 30 wt % to about 35 wt %, from about 15 wt % to about 30 wt %, from about 15 wt % to about 25 wt %, from about 15 wt % to about 20 wt %, or from about 20 wt % to about 30 wt %. In a further aspect, the plurality of polyphenols are present in an amount of from about 20 wt % to about 30 wt %.

The disclosed coffee extract also contains higher concentrations of the main chlorogenic acid, 5-caffeoylquinic acid, due to the low temperature of the roasting profile. Thus, in various aspects, the disclosed dried coffee extract contains 5-caffeoylquinic acid in an amount of from about 8% to about 15%, from about 8% to about 12%, from about 8% to about 10%, from about 10% to about 15%, from about 12% to about 15%, or from about 10% to about 12%.

In various aspects, the dried coffee extract comprises a plurality of polyphenols comprising 5-caffeoyl quinic acid (5-CQA). In a further aspect, the plurality of polyphenols comprise 5-CQA, feruloylquinic acid (FQA), and dicaffeoylquinic acid (DCQA). In a still further aspect, the plurality of polyphenols consists of 5-CQA, feruloylquinic acid (FQA), and dicaffeoylquinic acid (DCQA).

In various aspects, the 5-CQA is present in the dried coffee extract an amount of from about 6 wt % to about 20 wt %, from about 6 wt % to about 15 wt %, from about 6 wt % to about 10 wt %, from about 10 wt % to about 20 wt %, from about 15 wt % to about 20 wt %, or from about 10 wt % to about 15 wt %. In a further aspect, the 5-CQA is present in the dried coffee extract in an amount of from about 9 wt % to about 15 wt % (based on the total weight of the dried coffee extract).

As detailed herein, the disclosed coffee extract also contains higher concentrations of trigonelline due to the coffee beans having been roasted at lower temperatures, which prevents degradation of trigonelline, compared to conventionally roasted coffee beans. Thus, in various aspects, the disclosed dried coffee extract contains trigonelline in an amount of from about 3% to about 7%, from about 3% to about 5%, from about 5% to about 7%, or from about 4% to about 6%.

In various aspects, the dried coffee extract comprises trigonelline in an amount of from about 1 wt % to about 8 wt %. Thus, in various aspects, the dried coffee extract comprises trigonelline in an amount of from about 1 wt % to about 6 wt %, from about 1 wt % to about 4 wt %, from about 1 wt % to about 2 wt %, from about 2 wt % to about 8 wt %, from about 4 wt % to about 8 wt %, from about 6 wt % to about 8 wt %, or from about 2 wt % to about 6 wt %. In a further aspect, trigonelline is present in an amount of from about 3 wt % to about 7 wt %.

In various aspects, the dried coffee extract comprises an aromatic component.

In various aspects, the dried coffee extract comprises: (a) caffeine in an amount of from about 4 wt % to about 7 wt %; (b) a plurality of polyphenols comprising 5-caffeoyl quinic acid (5-CQA), wherein the 5-CQA is present in the dried coffee extract in an amount of from about 9 wt % to about 15 wt %; and (c) trigonelline in an amount of from about 3 wt % to about 7 wt %. In a further aspect, the plurality of polyphenols are present in an amount of from about 15 wt % to about 35 wt %.

As detailed herein, the disclosed coffee extracts are quite strong (not watery) due to the high solubility of the roasted coffee bean. Thus, in various aspects, the disclosed coffee extracts have a solubles concentration of at least about 90%, at least about 91%, at least about 92%, at least about 93%, at least about 94%, at least about 95%, at least about 96%, at least about 97%, at least about 98%, at least about 99%, or greater than 99%. In a further aspect, the dried coffee extract has a solubles concentration of at least about 90%. In a still further aspect, the dried coffee extract has a solubles concentration of at least about 95%.

In various aspects, the disclosed coffee extracts have an excellent extraction yield. Thus, in various aspects, the disclosed coffee extracts have an extraction yield of from about 15% to about 45%. In various further aspects, the disclosed coffee extracts have an extraction yield of, for example, about 15% to about 40%, about 15% to about 30%, about 15% to about 20%, about 20% to about 45%, about 20% to about 40%, about 20% to about 35%, about 20% to about 30%, about 30% to about 45%, about 30% to about 40%, about 30% to about 35%, about 35% to about 45%, about 35% to about 40%, or about 40% to about 45%. In various further aspects, the disclosed coffee extracts have an extraction yield of, for example, about 15%, about 20%, about 25%, about 30%, about 35%, about 40%, or about 45%. In a further aspect, the dried coffee extract has an extraction yield of from about 15% to about 45%.

In various aspects, the dried coffee extract has a lightness (L*) color test number (CTN) of about 50 or greater. In a further aspect, the dried coffee extract have a lightness (L*) color test number (CTN) of about 55 or greater, about 60 or greater, about 65 or greater, about 70 or greater, or about 75 or greater.

In various aspects, the dried coffee extract has a red-green (a*) color test number (CTN) of less than about 10. In a further aspect, the dried coffee extract have a red-green (a*) color test number (CTN) of less than about 8, less than about 6, less than about 4, or less than about 3.

In various aspects, the dried coffee extract have a blue-yellow (b*) color test number (CTN) of from about 40 to about 50. In a further aspect, the dried coffee extract have a blue-yellow (b*) color test number (CTN) of from about 42 to about 50, from about 44 to about 50, from about 46 to about 50, from about 48 to about 50, from about 40 to about 48, from about 40 to about 46, from about 40 to about 44, from about 40 to about 42, from about 42 to about 48, or from about 44 to about 46.

In various aspects, the dried coffee extract has a mean particle size of about 250 microns or less. Thus, in various aspects, the dried coffee extract has a mean particle size of about 225 microns or less, about 200 microns or less, about 175 microns or less, about 150 microns or less, about 125 microns or less, or about 100 microns or less.

### G. Food and Beverage Products

In one aspect, disclosed are food and beverage products comprising a disclosed coffee extract such as, for example, a disclosed liquid coffee extract. Thus, in various aspects, the liquid coffee extract comprises: (a) caffeine in an amount of from about 1 wt % to about 10 wt %; (b) a plurality of polyphenols; and (c) trigonelline, wherein the liquid coffee extract has a solubles concentration of at least about 90%; and wherein the coffee extract has an extraction yield of from about 15% to about 45%.

In one aspect, disclosed are beverages comprising a liquid and a disclosed dried coffee extract. Thus, in various aspects, the dried coffee extract comprises: (a) caffeine in an amount of from about 1 wt % to about 9 wt %; (b) a plurality of polyphenols comprising 5-caffeoyl quinic acid (5-CQA), wherein the 5-CQA is present in the dried coffee extract in an amount of from about 6 wt % to about 20 wt %; and (c) trigonelline in an amount of from about 1 wt % to about 8 wt %. In a further aspect, the liquid is water. In a still further aspect, the liquid is milk. In yet a further aspect, the beverage is selected from a tea and a coffee.

As would be understood by one of skill in the art, a disclosed coffee extract can be added to a beverage or a food product to add flavor to the beverage or the food product and/or to add desired compounds to the beverage or the food product (such as the presence of caffeine and/or chlorogenic acids). For example, a disclosed coffee extract can be used to add a flavor to a dessert. Alternatively, a disclosed coffee extract can be used to add caffeine and/or chlorogenic acids to a sparkling water. A disclosed coffee extract can also be used as the coffee base for coffee drinks such as lattes or blended coffees.

An additional benefit of the light color characteristics of the coffee extracts is that addition of a coffee extract to a beverage or food product results in minimal color change of the beverage or food product.

Examples of food and food products for which the coffee extracts are particularly well-suited include, but are not limited to, syrups, sauces, extracts, desserts (e.g., ice creams, flans, cakes, custards, pies, yogurts, shaved ice, tarts), and dough-based food products (e.g., croissants, waffles, pancakes, breads).

Examples of beverages for which the coffee extracts disclosed herein are particularly well-suited include, but are not limited to, coffee-based beverages such as instant coffees, espressos, hot brews, cold brews, lattes, blended coffees, cappuccinos, teas, fruit juices, smoothies, waters such as still waters and sparkling waters, liquors, liqueurs, mixtures thereof, carbonated beverages such as colas, lemon-lime sodas, fruit-flavored sodas, root beers, ginger ales, seltzers, tonic waters, beers, and sparkling waters.

In various aspects, the beverage further comprises one or more selected from a dairy component (e.g., cow's milk, coconut milk, oak milk, soy milk, almond milk, chia milk, cream, half-and-half, or a combination thereof), a sugar (e.g., granulated sugar, brown sugar, maple sugar, honey, cascara sugar, coconut sugar, or a combination thereof), a flavorant (e.g., a pineapple flavorant, a strawberry flavorant, an acai flavorant, a passionfruit flavorant, or a combination thereof), and a colorant (e.g., a pink colorant, a red colorant, a yellow colorant, or a combination thereof).

In various aspects, the beverage is selected from a tea (e.g., a black tea, a green tea, a passion tea, a white tea, an Earl Grey tea, a matcha tea, a Chai tea), a coffee, a fruit juice (e.g., strawberry juice, pineapple juice, white grape juice, or a combination thereof), a smoothie, an alcoholic drink, and a milkshake. In a further aspect, the beverage is a coffee. In a still further aspect, the coffee is selected from an espresso, an instant coffee, a cold brew, and a hot brew. In yet a further aspect, the coffee is a blended coffee beverage.

### F. Kits

In one aspect, disclosed are kits comprising the disclosed roasted coffee beans and one or more selected from: (a) an instrument for extracting roasted coffee beans; (b) a food or beverage product; (c) instructions for extracting roasted coffee beans; and (d) instructions for adding a coffee extract to a food or beverage product. In a further aspect, the instrument is a percolator or an Aeropress.

In one aspect, disclosed are kits comprising a disclosed liquid coffee extract and one or more selected from: (a) a food or beverage product; and (b) instructions for adding the liquid coffee extract to a food or beverage product.

In one aspect, disclosed are kits comprising a disclosed dried coffee extract and one or more selected from: (a) a beverage; and (b) instructions for adding the dried coffee extract to a beverage.

As would be understood by one of skill in the art, a disclosed coffee extract can be added to a beverage or a food product to add flavor to the beverage or the food product and/or to add desired compounds to the beverage or the food product (such as the presence of caffeine and/or chlorogenic acids). Thus, in various aspects, it may be desirable to package the two components together (e.g., as a kit).

As detailed herein, the disclosed coffee extracts can be provided a liquid form or can be dehydrated (dried) to form a solid form (solubles). Liquid forms of the coffee extracts can be, for example, coffee extracts that have been produced by extracting solubles with water via a method such as French press. Alternatively, solid forms of the coffee extracts can be obtained by, for example, drying the liquid extract to afford solid, coffee crystals have 100% or nearly 100% solubility in water. These coffee crystals can be directly dissolved in water (e.g., to provide an instant coffee). Without wishing to be bound by theory, the improved solubility of the disclosed roasted coffee beans, coffee extracts, and coffee crystals should also lead to improvements in stability (shelf life, taste) and in product yield.

In various aspects, the kit comprises a food or food product. Examples of foods and food products include, but are not limited to, syrups, sauces, extracts, desserts (e.g., ice creams, flans, cakes, custards, pies, yogurts, shaved ice, tarts), and dough-based food products (e.g., croissants, waffles, pancakes, breads).

In various aspects, the kit comprises a beverage. Examples of beverages include, but are not limited to, coffee-based beverages such as instant coffees, espressos, hot brews, cold brews, lattes, blended coffees, cappuccinos, teas, fruit juices, smoothies, waters such as still waters and sparkling waters, liquors, liqueurs, mixtures thereof, carbonated beverages such as colas, lemon-lime sodas, fruit-flavored sodas, root beers, ginger ales, seltzers, tonic waters, beers, and sparkling waters.

### G. Exemplary Method for Production of Soluble Coffee

As detailed herein, the specific processing attributes used to prepare white coffee solubles are significantly different due to the particular characteristics of the white coffee. Briefly, the green coffee beans are roasted as detailed herein above. As for grinding, it is known in the art that the structure of the coffee beans undergoes changes during the roasting process, transitioning from a plastic-like structure (green beans) to becoming brittle under normal roasting conditions. One must also consider the release of the silver skin during roasting, which is almost entirely removed from the coffee beans under normal roasting conditions. In contrast, for white coffee, the beans remain in an intermediary stage in terms of structure, leading to very hard beans. Thus, the application of different processing techniques, either cutting or blade disks grinders, can be used (instead of, for example, roller grinders). In addition, the granulation processes may need a coarser particle size than for normal roasted beans in order to address extraction back pressure issues. Further, in some cases, the application of pre-wetting techniques prior to extraction can be used, with water to coffee ratios around 1:2. Extraction can be performed using, for example, a battery of tall form percolators constituted of 5 to 8 percolators in operation. These can be operated under controlled temperatures or ambient as desired.

Importantly, a specific temperature profile must be maintained to protect the beneficial properties of the white coffee; namely, limiting temperatures to under 300° F. (˜150° C.), whereas conventional roasted coffees are typically processed at temperatures above 356° F. (180° C.). Particularly for white coffee roasting, due to its intrinsic characteristics, most of the silver skin remains attached to the beans. The silver skin tends to clog the percolators, leading to processing problems during extraction. To circumvent this problem, the pressures must be strictly controlled at least 1 Bar above the saturation vapor pressure. Flow inversions can be applied as well. For white coffee production, the wet part of the process should be implemented using low temperatures such as, for example, temperatures lower than 50° F. (10° C.), by cooling down the extracts as quickly as possible. Further, because the raw extract contains insoluble parts produced during the extraction percolators filtering, in various aspects, an additional step to remove these insoluble particles can be implemented. For the white coffee this can be achieved via a clarification step in which the extract is either filtered or centrifuged until the liquid gets clear of larger particles (e.g., about 5 micrometers and above). For some applications, the centrifuging can be done twice to achieve the desired transparency in the extract.

In order to explore all of the potential flavors produced during the white coffee processing thus far, the aromas can be removed from the clarified extract prior to concentration. Removal can be achieved by, for example, extract stripping or spinning followed by distillation. The recovered aroma stream can then be added back at variable ratios to the extract after concentration, thereby preserving more of the desired aroma characteristics. For some applications, such as, for example, beverages, where less flavor is recommended, the aroma removal step can be applied in the same manner, but the aroma stream is then discarded, leaving the concentrated extract more neutral.

In preparation for the drying step, the clarified extract can first undergo a concentration step by, for example, thermal evaporation. Once again the temperature is maintained at a much lower value than for normal roasted coffee extracts, e.g., 122-140° F. (50 to 60° C.). Other concentration techniques such as, for example, freeze concentration and reverse osmosis, can be applied as well. In this way, the total soluble solids can be increased to at least about 30%, at least about 35%, at least about 40%, at least about 45%, and, in some cases, greater than 45%.

The roasting process used for the disclosed white coffee can be similar to that applied for normal roasted coffee extracts, although the product obtained is much lighter in color (in addition to having the other distinct beneficial properties detailed herein). In various aspects, the drying tower can be equipped with devices such as hammers, wipers, or sound equipment to keep the inner walls clean throughout the process, thereby avoiding potential additional caramelization reactions.

Exemplary roasting temperatures are illustrated in Table 1 below.

TABLE 1

| | Bean | Air | Bean | Air |
|---|---|---|---|---|
| Roasting | Temperature | temperature | Temperature | temperature |
| time (min) | (° C.) | (° C.) | (° F.) | (° F.) |
| 0 | 25.0 | 558.0 | 77 | 1036.4 |
| 1 | 102.8 | 565.0 | 217.04 | 1049 |
| 2 | 99.0 | 559.0 | 210.2 | 1038.2 |
| 3 | 121.0 | 552.0 | 249.8 | 1025.6 |
| 4 | 138.0 | 560.0 | 280.4 | 1040 |
| 5 | 153.0 | 561.0 | 307.4 | 1041.8 |

The foregoing description illustrates and describes the disclosure. Additionally, the disclosure shows and describes only the preferred embodiments but, as mentioned above, it is to be understood that it is capable to use in various other combinations, modifications, and environments and is capable of changes or modifications within the scope of the invention concepts as expressed herein, commensurate with the above teachings and/or the skill or knowledge of the relevant art. The embodiments described herein above are further intended to explain best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended to the appended claims be construed to include alternative embodiments.

All publications and patent applications cited in this specification are herein incorporated by reference, and for any and all purposes, as if each individual publication or patent application were specifically and individually indicated to be incorporated by reference. In the event of an inconsistency between the present disclosure and any publications or patent application incorporated herein by reference, the present disclosure controls.

### H. Examples

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The Examples are provided herein to illustrate the invention, and should not be construed as limiting the invention in any way. Examples are provided herein to illustrate the invention and should not be construed as limiting the invention in any way.

The disclosed methods produce a coffee bean that can then be extracted to produce a coffee extract which is mild in taste, contains a higher level of chlorogenic acids relative to traditionally roasted coffee, and is soluble in water.

### 1. Evaluation of Coffee Roasting Profile

Green coffee beans of Colombian origin (Colombian Excelso Coffea Arabica) were roasted using a Probat P-series small roaster (batch capacity up to 30 kg) presenting all features of an industrial roaster. Coffee beans of Brazilian, Central American, Ethiopian, and Indonesian origin were also roasted and tested. The roaster was operated according to a proprietary roasting curve over a time span of about 13 min and 30 s. See FIG. 5. 50 g samples were collected every 20-30 s and immediately cooled down with cold air.

Referring to FIG. 5, panel (a) shows the raw coffee beans at the green, unroasted stage, before subjecting to any type of heating. At 270° F., the coffee beans began to pale in color as shown in panel (b). This temperature is the conventional roasting temperature for alternative, commercial white coffees. These beans were taste-tested and afforded a product with an herbal, astringent taste. At 327° F., the coffee beans exhibited an early yellow stage of coloring as shown in panel (c). These coffee beans had a significantly improved taste profile as compared to the coffee beans in panel (b), with the accompanying product tasting pleasant and savory. As the temperature is raised to 345° F., the coffee beans reached a yellow-tan stage of coloring (panel (d)), followed by a light brown stage at 370° F. (panel (e)), and a brown stage at 393° F. (panel (f)). The “1^{st} crack,” indicating that a large amount of the coffee bean's moisture has been evaporated, was reached at 401° F. as shown in panel (g). The first crack occurs due to water within the bean creating a great deal of pressure as it turns to steam. The “cracking” process continued through 415° F. (panel (h)), until the end of the crack was reached at 426° F. (panel (i)). The coffee beans roasted at temperatures 270 to 350° F. (e.g., panels (c) to (i) produced a light roast, with notes of cereal, savoury acid, fruits, and caramel. As the temperature was increased to 435° F., the coffee beans darkened in color (panel (j)), followed by a further darkening at 444° F. (panel (k)). The “2^{nd} crack,” due to build up of carbon dioxide becoming too great for the increasingly brittle bean structure, began at about 454° F. (panel (1)), continued through about 465° F. (panel (m)) to 474° F. (panel (n)). The darkest roast sold on the market, Italian roast, is achieved just after the 2^{nd} crack, at 486° F. (panel (o)). Once the coffee beans have reached 497° F., the beans begin to carbonize, just before “imminent fire” (panel (p)). The coffee beans roasted at temperatures 410 to 490° F. (e.g., panels (j) to (p) produced a very light to very dark roast, with a chocolatey, citrusy, rich, and bold flavor.

### 2. Color Testing

Color testing was performed on coffee beans derived from various roasts, including Colombian Excelso beans roasted at 5, 6, and 7 minutes as well as conventional roasts. The samples were visually analyzed for roasting color. Readings were taken on a Konica Minolta cR-410 photometer, and the results are shown in Table 2.

TABLE 2

| | | Lightness | Red-Green | Blue-Yellow |
|---|---|---|---|---|
| | Roasting time | (L*) | (a*) | (b*) |
| White | 5 min | 47.38 | 2.03 | 16.53 |
| Coffee | 6 min | 46.15 | 2.59 | 16.88 |
| | 7 min | 45.79 | 2.43 | 15.81 |
| Commercial | Very light roast | 29.09 | 3.80 | 4.26 |
| roasted | Light roast | 27.64 | 3.74 | 3.69 |
| coffee | Medium roast | 26.71 | 2.83 | 2.53 |
| | Dark roast | 26.39 | 2.42 | 1.82 |
| | Italian roast | 26.67 | 1.37 | 0.83 |

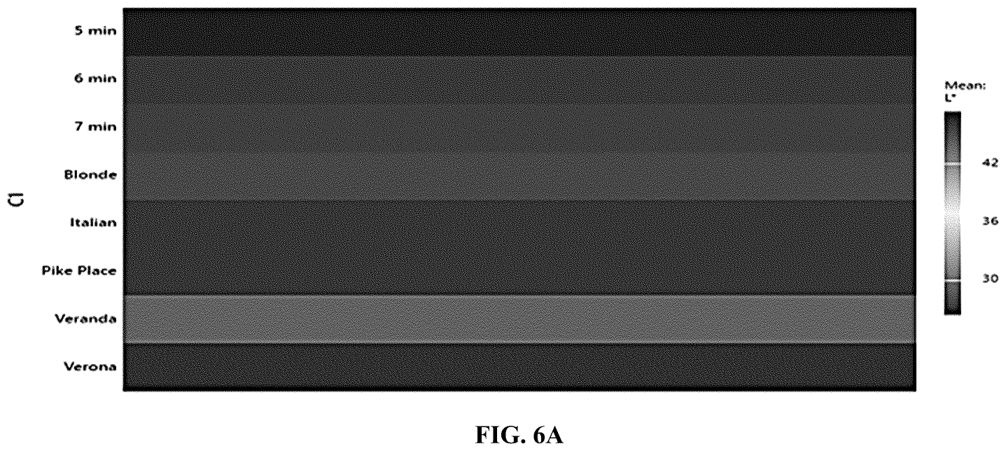

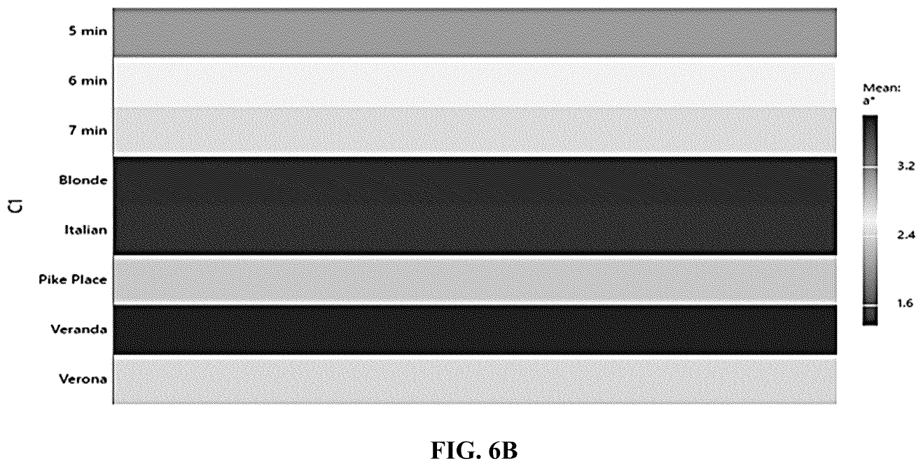

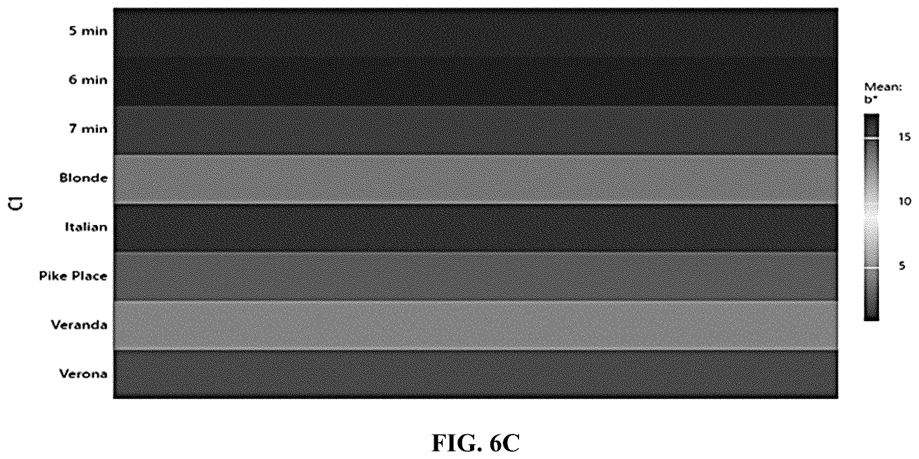

Numerical readings corresponding to L*, a*, and b* are shown in FIG. 6A, FIG. 6B, and FIG. 6C, respectively. As shown, the 5 min, 6 min, and 7 min exemplary white coffee roasts had significantly higher lightness (L*) readings compared to conventional light, medium, and dark roasts. Furthermore, the exemplary white coffee roasts exhibited mid-level a” readings, indicating that these roasts are in the middle of the red-green spectrum, and high b* readings, indicating that these roasts are more yellow in color, and significantly more yellow than the comparative roasts.

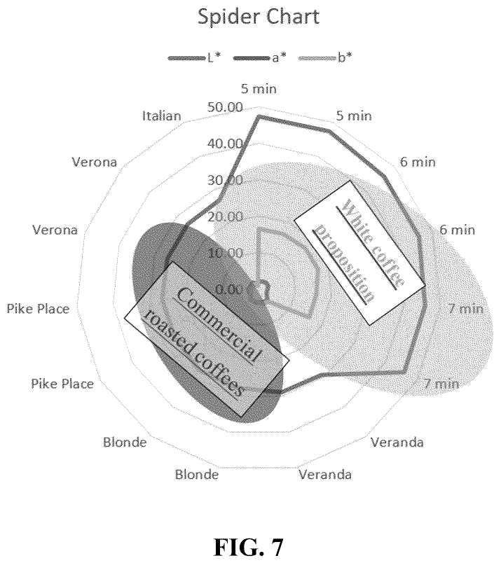

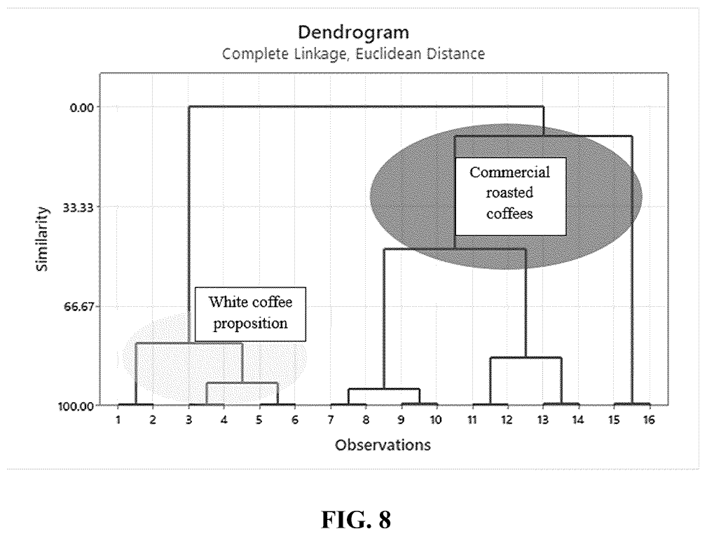

A spider chart constructed from the color readings is shown in in FIG. 7. This representation further exemplifies the differences in roasting color obtained from the exemplary white coffees compared to commercially roasted coffees. Furthermore, a dendogram constructed from this data is shown in FIG. 8, further highlighting the differences in roasting color.

### 3. Brewing of White Coffee Beans

The coffee samples were ground to different particle sizes, from coarser (French press) to fine (paper filter) and extracted with hot mineral water (about 90° C.) using a standardized soluble solids concentration of 1.5% wt. Following extraction, the samples were evaluated for taste and aroma by specialized coffee panelists.

### 4. White Coffee Beans

The white coffee was analyzed using High Performance Liquid Chromatography (HPLC) to quantify the amounts of caffeine (0.9-1.4 wt %), trigonelline (0.9-1.3 wt %), total polyphenols (as chlorogenic acids or CGAs) (5-8 wt %), and 5-caffeoylquinic acid (3-5 wt %).

### 5. Instant White Coffee

The instant white coffee (dried coffee extract) was evaluated for color and compared to commercial roasted instant coffees (see Table 3).

TABLE 3

| | Lightness | Red-Green | Blue-Yellow |
|---|---|---|---|
| | (L*) | (a*) | (b*) |
| Instant white coffee | 79.7 | 2.5 | 45.5 |
| Very light roasted commercial | 31.8 | 37.5 | 54.4 |
| instant coffee | | | |
| Very dark roasted commercial | 19.8 | 33.1 | 33.9 |
| instant coffee | | | |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of making a coffee extract, the method comprising:
(a) extracting roasted coffee beans at a pressure equal to or greater than a saturation vapor pressure, thereby providing an extract; and
(b) washing the extract at a temperature of less than about 50° F.

2. The method of claim 1, wherein extracting is via a percolator.

3. The method of claim 1, wherein extracting is via an Aeropress.

4. The method of claim 1, wherein, prior to the extracting step, the roasted coffee beans are ground to an average particle size of from about 8 mm to about 9 mm.

5. The method of claim 1, wherein the roasted coffee beans are not ground prior to the extracting step.

6. The method of claim 1, wherein the roasted coffee beans are extracted as whole beans.

7. The method of claim 1, wherein the method further comprises clarifying the extract.

8. The method of claim 7, wherein the clarifying step is repeated until the extract does not contain particles having a size of about 5 micrometers or greater.

9. The method of claim 1, wherein the method further comprises removing a plurality of aromatic components from the extract.

10. The method of claim 9, wherein the plurality of aromatic component comprises one or more selected from 2-furfurylthiole, 3-mercapto-3-methylbutylformate, 3-methyl-2-buten-1-thiol, 2-isobutyl-3-methoxypyrazine, 5-ethyl-4-hydroxy-2-methyl-3(2H)-furanone, 2,3-butanedione (diacetyl), 2,3-pentanedione, methional, 2-isopropyl-3-methoxypyrazine, vanillin, 4-hydroxy-2,5-dimethyl-3(2H)-furanone, 2-ethyl-3,5-dimethylpyrazine, 2,3-diethyl-5-methylpyrazine, 3-hydroxy-4,5-dimethyl-2(5H)-furanone and 5-ethyl-3-hydroxy-4-methyl-2(5H)-furanone.

11. The method of claim 1, wherein the method further comprises concentrating the extract.

12. The method of claim 11, wherein concentrating is via evaporation.

13. The method of claim 1, wherein the method further comprises drying the extract.

14. The method of claim 13, wherein dry is via spray drying.

15. A method of making a coffee extract, the method comprising:
(a) roasting coffee beans;
(b) extracting the roasted coffee beans at a pressure equal to or greater than a saturation vapor pressure, thereby providing an extract; and
(c) washing the extract at a temperature less than about 50° F.

16. The method of claim 15, wherein roasting is at a temperature of less than about 300° F. for a time period of about 10 minutes or less.

17. A liquid coffee extract comprising:
(a) caffeine in an amount of from about 1 wt % to about 10 wt %;
(b) a plurality of chlorogenic acids (CGAs); and
(c) trigonelline,
wherein the liquid coffee extract has a solubles concentration of at least about 90%; and
wherein the coffee extract has an extraction yield of from about 15% to about 45%.

18. A food or beverage product comprising the liquid coffee extract of claim 17.

19. The food or beverage product of claim 18, wherein the beverage is selected from a tea, a coffee, a fruit juice, a smoothie, an alcoholic drink, and a milkshake.

20. A kit comprising the liquid coffee extract of claim 17 and one or more selected from:
(a) a food or beverage product; and
(b) instructions for adding the liquid coffee extract to a food or beverage product.
